(19) United States
(12) Patent Application Publication
(10) Pub. No.: US 2002/0080826 A1
(43) Pub. Date: Jun. 27, 2002

(54) Method for improving the transmission quality of information offered from the internet

(75) Inventor: Jurgen Flehinghaus, Stuttgart (DE)

Correspondence Address: SUGHRUE, MION, ZINN, MACPEAK & SEAS, PLLC, 2100 Pennsylvania Avenue, N.W., Washington, DC, 20037-3213, US

(73) Assignee: ALCATEL

(21) Appl. No.: 10/000,361

(22) Filed: Dec. 4, 2001

(30) Foreign Application Priority Data
Dec. 23, 2000 (DE) 100 64 987.4

(51) Int. Cl. H04J 3/12

(52) U.S. Cl. 370/524

(57) ABSTRACT

In the case of information offered from the Internet such as, for example, moving images, large quantities of data have to be transmitted, requiring a large amount of bandwidth. This problem is solved, in that, in the transmission of large quantities of data, the Internet is excluded as a transmission path and the information is transmitted directly via the ISDN from the provider to the user, via a viewpoint, and the transmission quality is thus improved through combining what are to some extent inherently competing services, such as ISDN and Internet.

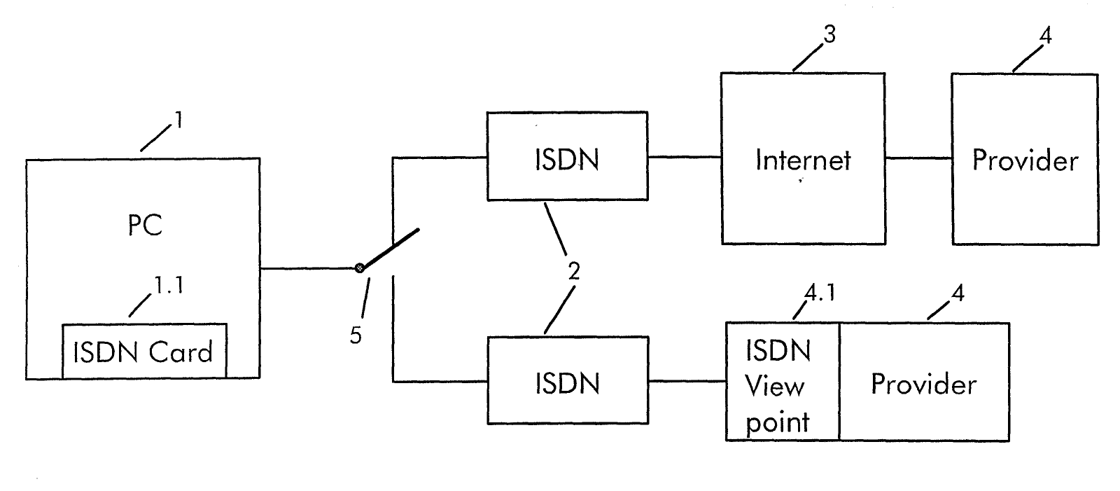

### BACKGROUND OF THE INVENTION

The invention is based on a priority application DE 100 64 987.4 which is hereby incorporated by reference.

The invention concerns a method which enables the transmission qualify of information offered from the Internet to be improved through the combination of ISDN (Integrated Services Digital Network) and Internet. In the case of offered information such as moving images, for example feature films, or large photographs, large quantities of data have to be transmitted, requiring a large amount of bandwidth. In practice, there is in many cases insufficient bandwidth available on the Internet transmission path, so that the transmission involves corresponding wait times and lack of image quality.

### SUMMARY OF THE INVENTION

This inadequacy is not remedied even by accessing the Internet via the integrated services digital network, ISDN, by means of dynamic regulation of bandwidth in dependence on the extent of the quantities of data to be transmitted, cf. Sablowski, Ralf: Über den D-Kanal online, Funkschau No. 12, 2000, pages 38-41, WEKA Fachzeitschriften Verlag GmbH, Gruber StraBe 46a, 85586 Poing. This possibility of dynamic bandwidth regulation is based on the assumption that, in the Internet connections of an ISDN-connected customer, connections with a low bandwidth requirement are essentially predominant.

Larger bandwidths, which are necessary for retrieving complex web-sites such as moving images, for example, or for data download, are required relatively infrequently by a user.

It is on this consideration that the AO/DI technology is based. AO (Always On) in this case denotes the continuous connection of the personal computer (PC) of the user to the switching center via the D channel of the ISDN connection. If extensive quantities of data are to be transmitted, one or two B channels can be additionally connected to the D channel by means of DI (Dynamic ISDN).When the current data transmission is completed, the system returns to D channel operation. Although the AO/DI technology does enable the bandwidth to be matched to the data quantities within certain limits, the problem is frequently unsolved due to the fact that the transmission of large quantities of data from the Internet to a PC involves long wait times and, sometimes, reduced image quality. This inadequacy is not remedied by either the AO/DI technology or a modem with a high transmission rate between the network and the PC, since the actual bottleneck in the transmission is the frequently overloaded Internet connection from a user to a provider or the Internet itself.

The object to be achieved by the invention, resulting from this problem, is to enable a user who has both an ISDN telephone facility and an Internet connection facility to achieve a higher quality of transmission of the information supplied by a provider. This object is achieved by the method described in the first claim.

The core of the invention consists in that, in the transmission of large quantities of data, the Internet is excluded as a transmission path and the provider is connected directly to the user via the ISDN and the transmission quality is thus improved through combining what are to some extent inherently competing services, such as ISDN and Internet.

The invention is now explained more fully with reference to an embodiment example. In the accompanying drawing, the FIGURE shows a block diagram illustrating the method according to the invention.

Represented in the FIGURE are a personal computer PC 1 with an ISDN card 1.1, which provides for ISDN telephone traffic from the personal computer 1, an integrated services digital network ISDN 2, an Internet 3 and a provider 4 of offered text, image and audio services with, if necessary, a viewpoint 4.1, by which images are directly prepared for transmission via the ISDN 2.

Normally, a connection to the internet 3 is established by the PC 1 with the ISDN card 1.1 via the ISDN 2, by means of a destination address to a provider 4. Information of a very wide range of types such as, for example, feature films, fashion shows, exhibitions in car showrooms, property for sale or auctions, can then be retrieved from the provider 4. In such cases, it has become apparent that, as the quantities of data increase, particularly in the case of moving images, the transmission quality diminishes very rapidly and the transmission time increases, these effects being caused in many cases not by the limited bandwidth of the terminal equipment of the user, but by the occasional overloading of the Internet. An improvement of the transmission quality is achieved if the provider 4 makes his information available via a viewpoint 4.1 for retrieval via the ISDN 2. The technology of the viewpoint 4.1 is currently applied, for example, for transmitting current weather situations of a particular location to a video-telephone or the display screen of the PC 1 via the ISDN.

Providers 4 with a viewpoint 4.1 will now indicate on their presentation pages that quality deterioration can occur in the Internet transmission due to the large quantity of data and that there is therefore the option of retrieving the same offered service in better quality via the ISDN 2. If this notice is “clicked”, the user is then asked whether he requires a higher-resolution ISDN connection for the available offered service. Upon confirmation by the user, the connection to the Internet 3 is interrupted and a connection, a “link” 5, is established to the viewpoint 4.1 of the provider 4 via the ISDN 2. The user can then select between a transmission via a B channel and a transmission via two B channels. Prior to completion of the ISDN transmission, the user is asked whether the original Internet connection is to be restored, so that the user has the option of returning to his initial connection state and accessing further providers 4 via the Internet 3.

Advantageously, therefore, it is thus possible, in a manner which can be controlled by the user, to leave the Internet 3 if required and initiate the transmission of the desired information via the ISDN 2 only, bypassing the Internet 3. By this means, requested video/audio transmissions can be received by the user with a substantially higher quality than transmission in the overloaded Internet. By means of the ISDN 2 and a viewpoint 4.1, the providers of moving images and sound in the Internet 3 can make their products available to the users in a better quality.

1. Method for transmitting to a user, via the integrated services digital network ISDN and with use of a viewpoint, information offered by a provider from the Internet, including the steps:
following establishment of a connection from a personal computer to the provider via the Internet by means of ISDN, a notice is contained in the information offered by the provider that the offered information can also be retrieved directly via the ISDN, in improved transmission quality, via a viewpoint,
for the purpose of improving the transmission quality of the offered information, the connection via the Internet is interrupted by the user and a connection is established to the viewpoint of the provider via the ISDN and the information is transmitted,
following completion of the transmission via the ISDN, the user selects whether or not the connection via the Internet is to be restored.

2. Method according to claim 1, the notice on the viewpoint of the provider appears on the display screen of the personal computer in such a way that the Internet connection being interrupted and the ISDN connection established automatically through a mouse click.

3. Method according to claim 1, wherein following establishment of the ISDN connection, the user can select whether the transmission is to be effected via a B channel or via two B channels.
